(19) United States
(12) Patent Application Publication
(10) Pub. No.: US 2025/0361007 A1
(43) Pub. Date: Nov. 27, 2025

(54) LONG-RANGE PAYLOAD DELIVERY SYSTEM AND METHOD

(71) Applicant: Daniel James Harold, Higganum, CT (US)

(72) Inventor: Daniel James Harold, Higganum, CT (US)

(21) Appl. No.: 18/670,071

(22) Filed: May 21, 2024

(51) Int. Cl. B64D 1/02; B64U 10/00; B64U 101/64; G05D 1/222; G05D 1/656; G05D 105/28; G05D 109/25; G05D 111/30

(52) U.S. Cl. CPC B64D 1/02; G05D 1/222; G05D 1/665; B64U 10/00; B64U 2101/64; B64U 2201/20; G05D 2105/28; G05D 2109/254; G05D 2111/30

(57) ABSTRACT

A delivery system includes an unmanned aerial vehicle (UAV) and a dropper device removably coupled to the UAV. The dropper device includes a retaining device to selectively attach cargo to the dropper device, an actuation device configured to cause a release of the cargo from the retaining device, and control hardware coupled to the actuation device and configured to actuate the actuation device in response to an encoded signal. The delivery system also includes a remote control device configured to generate and transmit the encoded signal.

### FIELD

The present disclosure relates to payload delivery systems and, more particularly, to systems and methods for unmanned and automated payload delivery systems and methods.

### BACKGROUND

Currently, Drones or Unmanned Aerial Vehicles (UAV) are utilized to deliver various types of payloads over distance. For example, sportsmen may utilize UAVs to deliver their fishing line over distances without the need for a manual cast. However, current systems either utilize a 433 MHz radio signal, a drone-mounted lighting system, or a series of UAV operator maneuvers to actuate the release mechanism to drop a UAV's payload. Existing radio signal solutions are only effective to 300 feet (100 meters) and can suffer from interference, while mounted lighting systems and UAV operator maneuvers add complications to the operation of UAV payload delivery systems.

As can be seen, there is a need for payload deliver systems and methods that address the above drawbacks.

### SUMMARY

In one aspect of the present disclosure, a delivery system includes an unmanned aerial vehicle (UAV) and a dropper device removably coupled to the UAV. The dropper device includes a retaining device to selectively attach cargo to the dropper device, an actuation device configured to cause a release of the cargo from the retaining device, and control hardware coupled to the actuation device and configured to actuate the actuation device in response to an encoded signal. The delivery system also includes a remote control device configured to generate and transmit the encoded signal.

In another aspect of the present disclosure, a method includes the user powering on a drone, a dropper mechanism, and a remote-control. Once powered on, the dropper mechanism is mounted to the drone, preferably with a strap, and a payload is added to the dropper mechanism. The drone is piloted, manually, semi-autonomously or autonomously, to a desired location for payload delivery. Once at the desired location the remote-control button is actuated which transmits a signal to the dropper mechanism. When the signal is received at the dropper mechanism the payload is released. According to a preferred embodiment, before transmission the signal is encoded, and the signal is transmitted as a 915 MHz radio wave signal. In another aspect of the present disclosure, a system comprises at least one Unmanned Aerial Vehicle, at least one remote for transmitting a signal, and at least one dropper mechanism securable to the at least one Unmanned Aerial Vehicle, the dropper mechanism further comprises, one or more processors configured to execute the instructions to perform a method, the method comprises the steps of receiving, at the dropper mechanism, the signal from the remote, and actuating the dropper mechanism to release a payload, in response to the received signal. Further aspects of the system include the remote having one or more processors is configured to execute the instructions to perform the method further comprises, receiving, at the remote, an actuation signal of a button on the remote, encoding, at the remote, a 915 MHz radio wave signal and transmitting, in response to the actuation signal, the radio wave signal.

### BRIEF DESCRIPTION OF THE DRAWINGS

FIG. 1 is a perspective view of a long-range payload delivery system, according to aspects of the present disclosure;

FIG. 2 is a perspective view of a dropper device of the long-range payload delivery system of FIG. 1, according to aspects of the present disclosure;

FIG. 3 is an exploded view of the dropper device of the long-range payload delivery system of FIG. 1, according to aspects of the present disclosure;

FIG. 4 is an exploded view of a remote control device of the long-range payload delivery system of FIG. 1, according to aspects of the present disclosure; and

FIG. 5 is a flow chart of an operation of the long-range payload delivery system of FIG. 1, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Traditional UAV payload delivery systems all require release mechanisms, and traditionally, these mechanisms are divided into radio wave release mechanisms, lighting mechanisms, and operator maneuver mechanisms. Traditional radio wave release mechanisms are unencoded and operate at 433 MHZ, which means that this type of mechanism can only operate at 300 ft (100 m) maximum and is subject to interference due to lack of encoding. Traditional lighting mechanisms require complicated LEDs to be attached to the UAV. Traditional operator maneuver mechanisms require a UAV pilot to execute a complicated maneuver or series of maneuvers to release a payload, which is disadvantageous for a novice drone operator.

Broadly, an embodiment of the present disclosure provides a system and method for delivering a payload via a UAV to a location utilizing an encoded 915 MHz radio wave signal sent from a remote control that actuates a dropper mechanism that is attached to the UAV. The system and method includes a remote control with a simple interface that subsequently delivers a 915 MHz encoded radio wave signal, that provides extended range and protection from interference to a dropper mechanism that is easily securable to a UAV

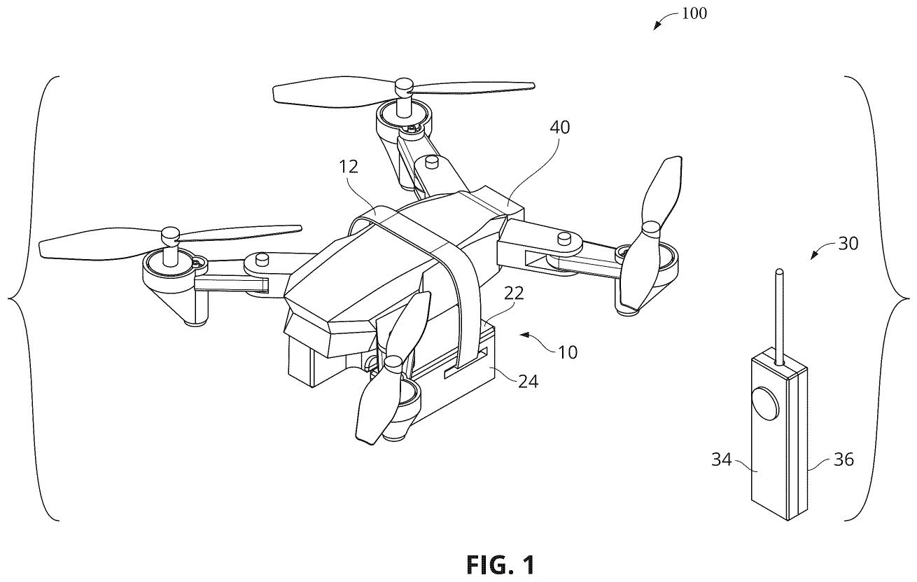

Referring now to FIG. 1-5, FIG. 1 illustrates a long-range payload delivery system 100 (hereinafter delivery system 100), according to aspects of the present disclosure. While FIG. 1 illustrates examples of components of the delivery system 100, additional components can be added and existing components can be removed and/or modified.

As illustrated in FIG. 1, the delivery system 100 includes a UAV 40, a remote control 30, and a dropper device 10. The dropper device 10 can be secured to the UAV 40 by a strap 12. For example, the dropper device 10 can be positioned under a bottom side (belly) of the UAV 40 such that the strap 12 extends around the body of the UAV 40. The dropper device 10 and the remote control 30 include electrical and mechanical components that allow the operation of the delivery system 100.

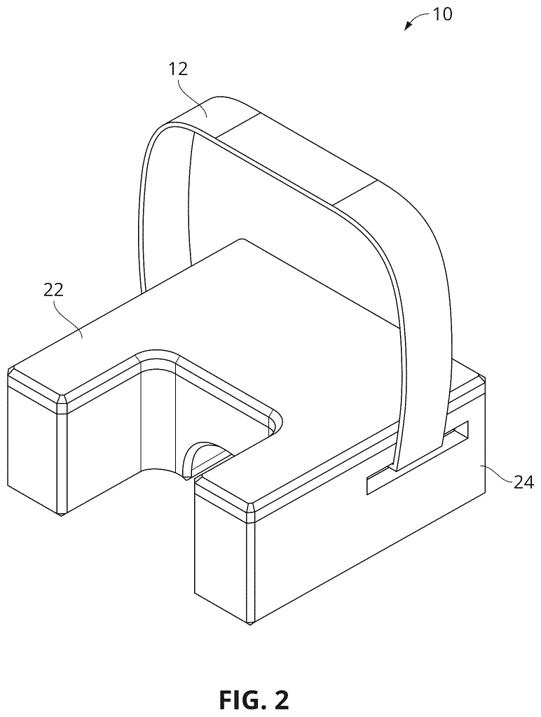

As illustrated in FIG. 1 and further illustrated in FIG. 2, the dropper device 10 includes a dropper body 24 and a cover 22. The dropper body 24 includes installation holes disposed opposite each other on sidewalls of the dropper body 24. The strap 12 can be installed in dropper body 24 through the installation holes.

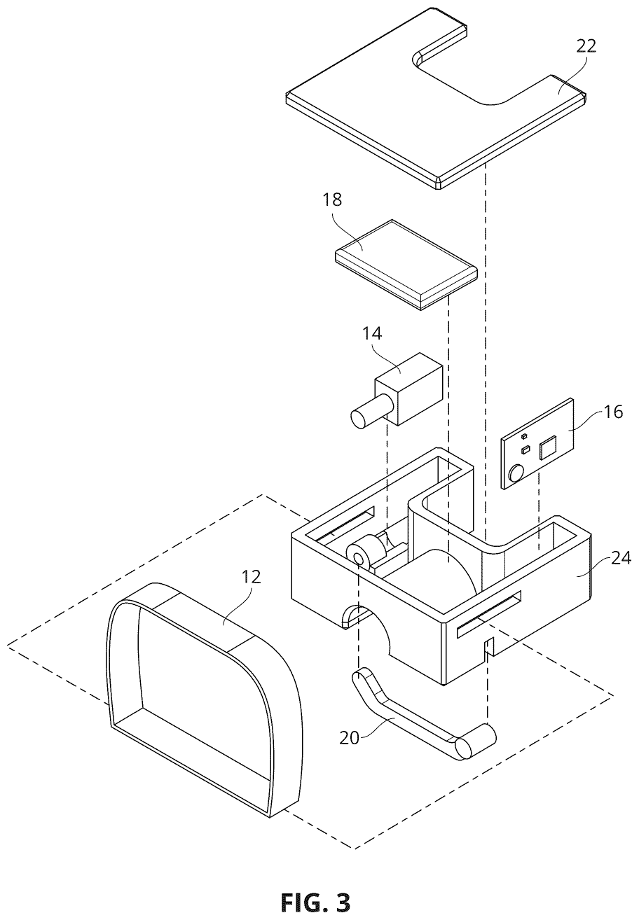

As illustrated in FIG. 3, the dropper device 10 includes a dropper hook 20. The dropper hook 20 can be installed at one end on solenoid 14 and can be free or removably attached at the other end to the dropper body 24. For example, the dropper hook 20 can be positioned adjacent to a bottom surface of the dropper body 24. The dropper body 24 can include a cavity in the bottom surface, which can accommodate attachment devices of the cargo carried by the dropper device 10. The cover 22 provides protection and security to the internal components of the dropper body 24. The cover 22 can fixably attached to the dropper body 24 thereby forming a top surface of the dropper body 24

The dropper device 10 also includes a control hardware 16, e.g., a printed circuit board. The control hardware 16 can be installed inside of the dropper body 24, and contains electrical components to perform the functionality of the dropper device 10, for example, operate the dropper hook 20. In embodiments, the control hardware 16 can include one or more processing devices, one or more memory devices, one or more communication devices, and one or more electrical components that control the electro-mechanical components, e.g., the solenoid 14, of the dropper device 10. The dropper device 10 can also include a power source 18, e.g., a battery, that provides power to both the solenoid 14 and the control hardware 16.

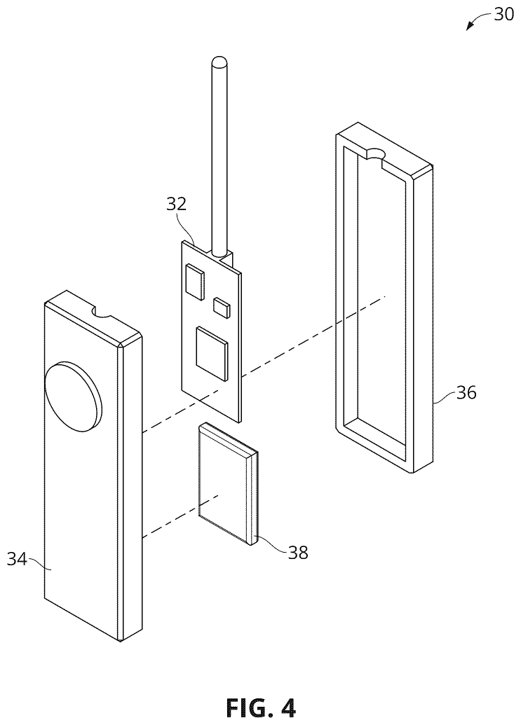

As illustrated in FIG. 4, the remote control 30 includes a back cover 36 and a front cover 34. The front cover 34 can include one or more a user interfaces. The remote control 30 also includes control hardware 32 that contains electrical components to perform the functionality remote control 30. In embodiments, the control hardware 32 can include one or more processing devices, one or more memory devices, one or more communication devices, and one or more electrical components. The remote control 30 can also include a power source 38, e.g., a battery, that provides power to the control hardware 32. The control hardware 32 can be configured to encode and transmit a radio wave signal via the one or more communication devices. In a preferred embodiment, the radio wave signal is encoded utilizing any known encoding scheme, and is transmitted as a 915 MHz wave.

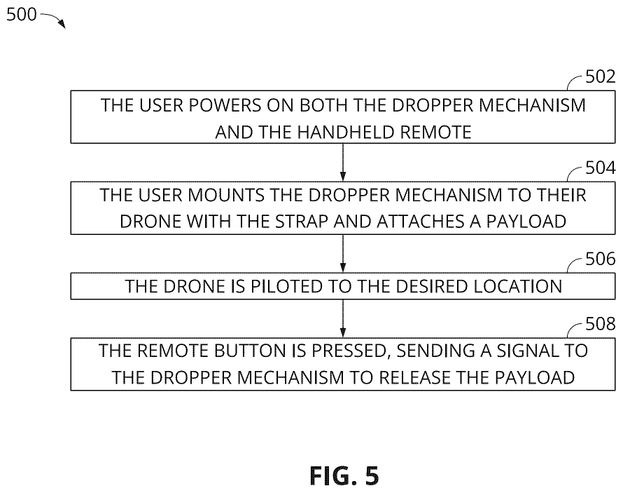

FIG. 5 illustrates a method for delivering payload over long ranges utilizing a UAV, according to aspects of the present disclosure. While FIG. 5 illustrates various stages of the method for delivering payload, additional stages can be added, and existing stages can be removed and/or reordered. Method 500 begins at step 502 where a user may power on the dropper device 10 and the remote control 30, wherein power can provided to the dropper device 10 through power source 18 and power can be provided to the remote control through power source 38. At step 504, the user can mount the dropper mechanism 10 to a UAV 40, using strap 12, and the user can mount or affix a payload to the dropper mechanism, using the dropper hook 20. At step 506, the UAV is piloted to a desired location, it is to be understood that any known mechanism for piloting a UAV can be utilized. For example, piloting can be performed manually by a UAV operator, semi-autonomously or fully autonomously. At step 508, once a desired location is reached, a user interface is pressed on the remote control 30, which encodes a signal, using control hardware 32, and sends the encoded signal to the dropper device 10. The dropper device 10 receives, decodes, and executes the encoded signal, at the control hardware 16, which causes solenoid 14 to actuate, subsequently releasing dropper hook 20. The release of dropper hook 20 causes the payload affixed to the dropper hook 20 to also be released. In a preferred embodiment, the encoded signal is a 915 MHz radio wave signal.

While FIGS. 1-4 illustrates one remote control 30, one UAV 40 and one dropper device 10, the environment can include multiple remote controls 30, multiple UAVS 40 and multiple dropper device 10 operated by the user or operated by other users.

As discussed above, the control hardware 16 and control hardware 32 can include one or more processing devices, herein processing devices, coupled to one or more communication devices. The processing device is also coupled to a memory device, and an input/output (“I/O”) interface. In embodiments, the communication interface enables the remote control 30 to communicate with other devices, such as the dropper device 10, and systems via encoded signals generated by the communication devices.

The processing device, the communication device, the memory device, and the I/O interface can be interconnected via a system bus. The system bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device, the system can include multiple processing devices, whether the same type or different types.

The memory device can be and/or include computerized storage medium capable of storing electronic data temporarily, semi-permanently, or permanently. The memory device can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device.

The communication device enables the remote control 30 and the dropper device 10 to communicate. The communication device can include, for example, a networking chip, one or more antennas, and/or one or more communication ports. The communication device can generate radio frequency (RF) signals and transmit the RF signals via one or more of the antennas. The communication device can generate electronic signals and transmit the RF signals via one or more of the communication ports. The communication device can receive the RF signals from one or more of the communication ports. The electronic signals can be transmitted to and/or from a communication hardline by the communication ports. The communication device can generate optical signals and transmit the optical signals to one or more of the communication ports. The communication device can receive the optical signals and/or can generate one or more digital signals based on the optical signals. The optical signals can be transmitted to and/or received from a communication hardline by the communication port, and/or the optical signals can be transmitted and/or received across open space by the communication device.

The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A delivery system, comprising:
an unmanned aerial vehicle (UAV);
a dropper device removably coupled to the UAV, the dropper device comprising:
a retaining device to selectively attach cargo to the dropper device,
an actuation device configured to cause a release of the cargo from the retaining device, and
control hardware coupled to the actuation device and configured to actuate the actuation device in response to an encoded signal; and
a remote control device configured to generate and transmit the encoded signal.

2. The delivery system of claim 1, wherein the retaining device of the dropper device is a hook and the actuation device is a solenoid.

3. The delivery system of claim 1, wherein the remote control device is configured to generate the encoded signal as a radio frequency signal having a frequency of 915 MHz.

4. The delivery system of claim 1, wherein the remote control device further comprises a user interface that initiates generation of the encoded signal in response to user input.

5. A method for delivering a payload utilizing an Unmanned Aerial Vehicle, the method comprising:
piloting, using the unmanned aerial vehicle (UAV), the payload to a desired location;
determining the desired location has been reached;
receiving, at a dropper mechanism of the UAV, a signal; and
actuating a solenoid of the UAV to release a payload.

6. The method of claim 5, wherein the signal is an encoded signal.

7. The method of claim 6, wherein the encoded signal is a 915 MHz radio wave.

8. A system comprising:
at least one unmanned aerial vehicle (UAV);
at least one remote for transmitting a signal;
at least one dropper mechanism securable to the at least one unmanned aerial vehicle (UAV), the dropper mechanism comprising:
one or more processors configured to execute the instructions to perform a method, the method comprising:
receiving, at the dropper mechanism, the signal from the remote; and
actuating the dropper mechanism to release a payload, in response to the received signal.

9. The system of claim 8, wherein the at least one remote comprises:
one or more processors is configured to execute the instructions to perform the method further comprising:
receiving, at the remote, an actuation signal of a button on the remote;
encoding, at the remote, a radio wave signal;
transmitting, in response to the actuation signal, the radio wave signal.

10. The system of claim 9, wherein the radio wave signal is a 915 MHz radio wave signal.

11. The system of claim 8, wherein the actuating step further comprises:
releasing, by a solenoid installed in the dropper mechanism, a hook, wherein the hook secures the payload.
